(19) United States
(12) Patent Application Publication
(10) Pub. No.: US 2024/0186816 A1
(43) Pub. Date: Jun. 6, 2024

(54) Portable Power System

(71) Applicant: Samuel Jackson, Mt. Pleasant, MI (US)

(72) Inventor: Samuel Jackson, Mt. Pleasant, MI (US)

(21) Appl. No.: 18/076,061

(22) Filed: Dec. 6, 2022

(51) Int. Cl. H02J 7/14; H02K 7/00; H02K 7/18

(52) U.S. Cl. CPC H02J 7/1469; H02K 7/003; H02K 7/1823

(57) ABSTRACT

The Self Powered Generator is the only product of its kind that has the capability of producing its own power by activating a self-propelling alternator/turbine to collect and store that power in a battery output. This unprecedented device is uniquely designed with durable, high-quality materials to ensure complete functionality and serves to aid in domestic or commercial settings. Multiple motors, regulators and alternators and switches and wires are added to a common drive shaft per load needs and design goals.

### BACKGROUND

Among the many power generating technologies employed today, solar panels and gas generators are currently some of the most common. These systems, however, require the use of extra materials such as solar panels or gas, which over time, can become costly and inconvenient even though it provides an improved alternative. There have been no products available as original equipment or as an aftermarket to address this problem.

A power generating apparatus that does not require the use of extra materials such as solar panels, and gas, and is cheaper and convenient to use, is not being met by any known device or system at present. There have been no products available as original equipment or as an aftermarket to address this problem either.

### SUMMARY OF THE INVENTION

The main purpose of the present disclosure is to provide users with an independent power system that uses an alternator/turbine to produce energy and store it for utilization.

A portable power system comprising a drive shaft, a primary motor configured to torque the drive shaft, a primary alternator configured to receive the drive shaft and transfer the torque on the drive shaft into electricity therefrom, a regulator configured to enable a change in the torque on the drive shaft per a load thereon; and a primary battery in communication with the primary alternator and configured to store a charge from the electricity. Extra alternators/turbines are added per need in groups of multiple generators and one motor according to load and design constraints

### BRIEF DESCRIPTION OF THE DRAWINGS

FIG. 1 a front perspective view of a first portable power system in accordance with an embodiment of the present disclosure.

FIG. 2 a front perspective view of a second portable power system in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

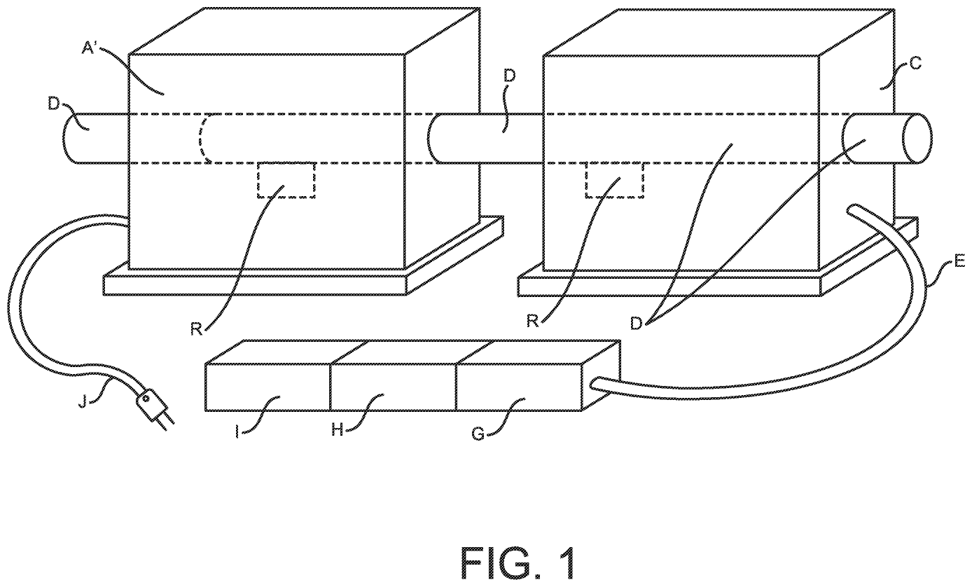

FIG. 1 a front perspective view of a first portable power system including a motor referenced as A, batteries and CPU for monitoring and access to outlets and USBs referenced as B, alternator/turbine referenced as C, drive shaft or metal bar referenced as D, series and parallel wiring referenced as E, belt-gear system referenced as F, power cord J, housing unit for USB parts and extra outlest referenced as H, housing unit for plug/cord referenced as I and regulator R in accordance with an embodiment of the present disclosure. The following picture below shows the extra two alternators/turbines beside the one motor and alternator/turbine.

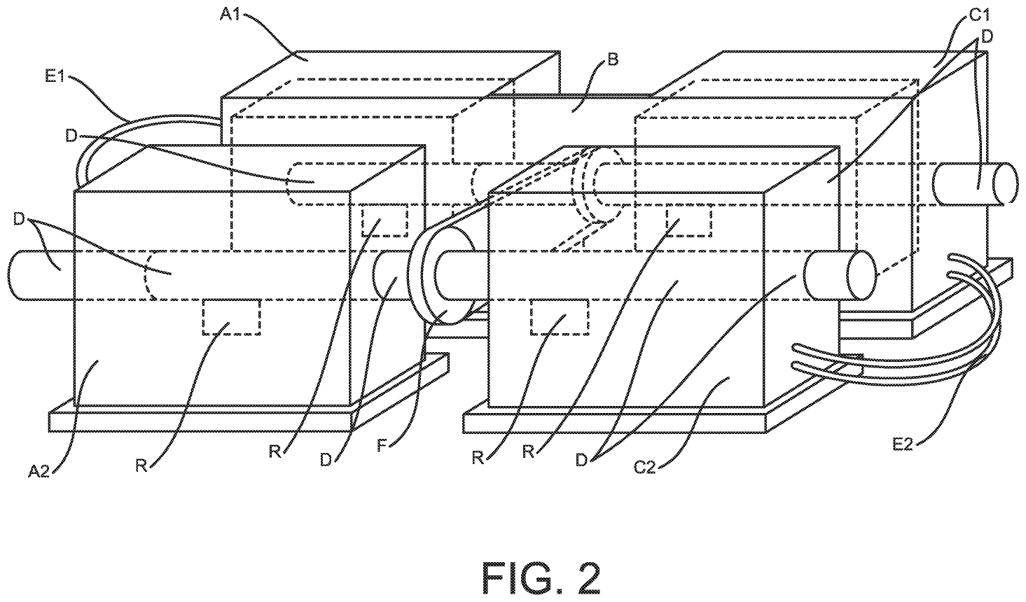

FIG. 2 a front perspective view of a second portable power system including a primary motor referenced as A1, a secondary motor referenced as A2, a primary alternator/turbine referenced as C1, a secondary alternator/turbine as C2, a drive shaft or metal bar referenced as D, wiring referenced as E, and regulator R. A primary battery referenced as G, a Housing unit for USB parts and extra outlets referenced as H, a housing unit for plug/cord referenced as I, a power cord referenced as J, are not shown but included in accordance with an embodiment of the present disclosure. A secondary battery is also in communication with the primary and secondary alternator as needed to maintain a predetermined torque on the drive shaft. Batteries, motors and alternators are in communication with each other via a series and a parallel connection of wires and cables according to E1 and E2. For instance, E1 and E2 as shown connected to a power outlet and a power ground configure a parallel connectivity where a daisy chain configuration puts respective components in a series connection and electrical communication. Therefore, FIG. 2 shows the extra two 80 alternators/turbines beside the one motor and alternator/turbine depicted in FIG. 1.

The present disclosed portable generator, also known as “The Self Powered Generator”, offers a modern means to successfully generate and house or store power from an alternator or turbine which is designed to infinitely run and produce a continuous electrical output that consumers can draw from to power diverse necessities. The Self Powered Generator introduces a novel portable generator that powers an alternator or turbine through a primary motor. With advanced technology, the alternator will then store the energy into a battery that users can easily access; thus, individuals will no longer have to purchase or install solar panels, or purchase gas for refueling, allowing for an improved alternative means to ensure power access. This innovative, top-quality product ensures a fully operational power generator that produces its own energy. The motor is configured to be on the same shaft as the alternator and/or the turbine. This configuration allows additional alternators and/or turbines to be added as needed to one motor to charge multiple batteries primarily for home use. A timer shutoff will stop the motor when the battery or batteries have reached full charge.

The portable power system further comprises a secondary motor configured on the drive shaft to increase the torque. In response to an increase of load on the drive shaft, the secondary alternator on the drive shaft shares the transfer of torque with the primary alternator via the primary regulator.

The primary alternator senses the torque on the drive shaft via a belt gear connecting the drive shaft to a shaft of the primary alternator. A shutoff switch is configured to stop the primary motor based on a full charge in the primary battery. A secondary battery is configured to charge in series or in parallel with the primary battery. The shutoff switch stops the primary motor based on a full charge in a secondary battery in communication with the primary alternator.

The regulator turns on and off the primary motor and a secondary motor to keep the torque constant based on the load on the drive shaft. The regulator also turns on and off a secondary motor to keep the torque constant based on the load on the drive shaft. The regulator furthermore turns on and off the primary or secondary alternator based on the charge level in the primary or the secondary battery. Another regulator is configured to another drive shaft for a secondary motor and a secondary alternator.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A portable power system comprising:
a drive shaft;
a primary motor configured to torque the drive shaft;
a primary alternator configured to receive the drive shaft and transfer the torque on the drive shaft into electricity therefrom;
a regulator configured to enable a change in the torque on the drive shaft per a load thereon; and
a primary battery in communication with the primary alternator and configured to store a charge from the electricity.

2. The portable power system of claim 1, further comprising a secondary motor and additional motors based on a load need.

3. The portable power system of claim 1, wherein one of the primary motor and an additional motor comprises a manually cranked input shaft.

4. The portable power system of claim 1, wherein one of the primary motor and an additional motor comprises a wind cranked turbine.

5. The portable power system of claim 1, wherein one of the primary motor and an additional motor comprises a steam cranked turbine.

6. The portable power system of claim 1, wherein one of the primary motor and an additional motor comprises a bicycle cranked input shaft.

7. The portable power system of claim 1, wherein one of the primary motor and an additional motor comprises a water cranked turbine.

8. The portable power system of claim 1, further comprising a secondary motor configured on the drive shaft to increase the torque via the regulator per an increase of load on the drive shaft.

9. The portable power system of claim 1, further comprising a secondary alternator configured on the drive shaft to share the transfer of torque with the primary alternator via the regulator.

10. The portable power system of claim 1, wherein the primary alternator receives the torque on the drive shaft via a belt gear connecting the drive shaft to a shaft of the primary alternator.

11. The portable power system of claim 1, further comprising a shutoff switch configured to stop the primary motor based on a full charge in the primary battery.

12. The portable power system of claim 1, further comprising electrical cables configured to transfer the electricity from the primary alternator to the primary battery.

13. The portable power system of claim 1, further comprising a secondary battery configured to charge in series with the primary battery.

14. The portable power system of claim 1, further comprising a secondary battery configured to charge in parallel with the primary battery.

15. The portable power system of claim 1, further comprising a shutoff switch configured to stop the primary motor based on a full charge in a secondary battery in communication with the primary alternator.

16. The portable power system of claim 1, wherein the regulator turns on and off the primary motor and a secondary motor to keep the torque constant based on the load on the drive shaft.

17. The portable power system of claim 1, wherein the regulator turns on and off a secondary motor to keep the torque constant based on the load on the drive shaft.

18. The portable power system of claim 1, wherein the regulator turns on and off the primary alternator based on the charge level in the primary battery.

19. The portable power system of claim 1, wherein the regulator turns on and off a secondary alternator based on the charge level in a secondary battery in communication with the secondary alternator.

20. The portable power system of claim 1, further comprising another regulator configured to another drive shaft for a secondary motor and a secondary alternator.
